(19) United States
(12) Patent Application Publication
(10) Pub. No.: US 2022/0245158 A1
(43) Pub. Date: Aug. 4, 2022

(54) RECOMMENDATION AND PREDICTION ENGINES FOR VIRTUAL AND HYBRID EVENTS

(71) Applicant: Social27 Inc., Redmond, WA (US)

(72) Inventors: Ikroop Singh Kehal, Redmond, WA (US); Bhalinder Singh Kehal, Redmond, WA (US)

(73) Assignee: Social27 Inc., Redmond, WA (US)

(21) Appl. No.: 17/166,010

(22) Filed: Feb. 3, 2021

(51) Int. Cl. G06F 16/2457; G06F 16/242; G06F 16/25; G06N 20/20; G06K 9/62

(52) U.S. Cl. CPC G06F 16/24573; G06F 16/244; G06K 9/6256; G06F 16/24578; G06N 20/20; G06F 16/254

(57) ABSTRACT

A system for making recommendations and predictions to an end-user of a virtual event or hybrid event is disclosed, including a virtual event platform to provide an interactive user interface for a virtual event. A recommendation and analytics server receives a plurality of interests and transmit the plurality of interests to an analytics engine and recommendation engine. The analytics engine and recommendation engine provide a response including one or more results to the user. The recommendation and prediction engine comprises a plurality of machine learning models to generate one or more recommendations, one or more predictions, and one or more matching scores to a user.

### TECHNICAL FIELD

The embodiments generally relate to computerized systems with which attendees, companies, and sponsors of a virtual and or hybrid event can interact, and more specifically relates to a recommendation engine used by attendees of a virtual and or hybrid event to suggest valuable interactions and events specific to the attendee.

### BACKGROUND

Recommendation and Prediction engines are a type of information filtering systems that are utilized on various platforms to recommend and predict what value a user would associate with an item or with another user. For example, existing music and movie services seek to recommend songs and films, respectively, based on an item's characteristics (e.g., classical music, horror films), the user's interests based on past behavior (e.g., songs or films previously selected), similar user's interests, or all three. More interactions between a user and a recommendation and prediction engine result in more information about the user's preferences (e.g., preferred items). As the information (data) associated with users increases, the accuracy in the predictions provided by the recommendation and prediction engine increases. For example, a user with an extensive history of accessing films will receive recommendations for movies that are more likely to be preferable to the user than the films suggested to a user with a limited history of accessing films.

A cold start for recommendation and prediction engine is an issue based on a lack of information associated with a user or an item. The lack of information can be based on the start-up of a new recommender, a new item added to the system, or a new user registered with the system. In such situations, the recommendation and prediction engine cannot accurately suggest which items the user may preferably be interested in.

Virtual events and Hybrid events, including, e.g., trade shows, conferences, and conventions, are becoming more common. Virtual events are prone to the cold start issue because the event is entirely new, the attendees are new, the sponsors are new, the speakers are new, and/or the items of interest are new. As a result, it can be difficult for users to navigate a virtual event environment and achieve their objectives for attending the event, such as, e.g., networking, learning, and entertainment. In a virtual environment, the recommendation and prediction engine must react quickly to provide relevant recommendations and predictions for the user in order to retain the user or to inspire user engagement in future virtual events. Conventional filtering algorithms, such as matrix factorization and clustering, do not work well in a cold-start scenario. Accordingly, a need exists for a recommendation and prediction engine that can operate at high speeds to provide accurate suggestions for an attendee or sponsor at a virtual event.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for making recommendations and predictions to an end-user of a virtual event or hybrid event, including a virtual event platform to provide an interactive user interface for a virtual event. A recommendation and analytics server receives a plurality of interests and transmit the plurality of interests to an analytics engine and recommendation engine. The analytics engine and recommendation engine provide a response including one or more results to the user. The recommendation and prediction engine comprises a plurality of machine learning models to generate one or more recommendations, one or more predictions, and one or more matching scores to a user.

Systems and methods are disclosed for filtering and modeling information for a virtual event. In some embodiments, the virtual event is a cold start virtual event. In some embodiments, the recommendation and prediction engine is configured to request and receive information from a user at the event. In some embodiments, the inputted information identifies various topics or areas of interest of the user. In some embodiments, the systems and methods analyze entity biographies, social media profiles, company webpages, or other information to make inferences and connections between entities.

In some embodiments, the recommendation and prediction engine is further configured to formulate and display user-specific recommendations based on the users interactions before, during, or after the virtual or hybrid event. The outputted display of user-specific recommendations can include, e.g., other attendees, particular speakers, contacts, sub-events within the virtual event, exhibition booths, or any other recommendations matching the user's inputted areas of interest.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a flow diagram of the recommendation and prediction engine's ETL (Extract, transform, load) and model training pipeline according to some embodiments described herein;

FIG. 2 illustrates a flow diagram of the inference pipeline in accordance with the recommendation and prediction engine in FIG. 1;

FIG. 3 depicts an example JSON (JavaScript Object Notation) graph in accordance with the recommendations and prediction engine in FIG. 1;

FIG. 4 illustrates a display of a recommendations and predictions output in accordance with the recommendation and prediction engine in FIG. 1;

FIG. 5 illustrates a display showing certain potential areas of interest that a user can select during event onboarding, in accordance with the recommendation and prediction engine in FIG. 1;

FIG. 6 illustrates a display showing specific event recommendations for a user based on the areas of interest inputted by the user during onboarding, in accordance with the recommendation and prediction engine in FIG. 1;

FIG. 7 illustrates a display showing recommended attendees and sponsors, in accordance with the recommendation and prediction engine in FIG. 1; and

FIG. 8 illustrates a computer system, which may be utilized to operate the recommendation and prediction engine in FIG. 1.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “virtual event” refers to any event held over a network connection between users of the system, including, e.g., virtual conferences, virtual conventions, hybrid events, virtual meetings, virtual presentations, and various activities involving the same.

As used herein, the term “user” or “users” refers to a person interacting with or through the virtual event, including, e.g., event attendees, businesses, sponsors, speakers, virtual event planners, and administrators.

As used herein, the term “entity” or “entities” refers to a user (e.g., an attendee, speaker, or sponsor), event session, topic (area of interest), or sub-event (e.g., happy hour). Each entity can have a set of attributes. For example, an attendee has attributes for their first name, last name, number of times she has engaged another entity in a virtual event, etc.

As used herein, the term “relationship” or “relationships” refers to a shared attribute among entities. For example, an attendee and a sponsor have a relationship when they share an area of interest. Similarly, a plurality of attendees has a relationship when they attend the same session of the virtual event.

In various embodiments of the present disclosure, systems and methods are disclosed for filtering and modeling information for a virtual event. In some embodiments, the system and methods comprise a recommendation and prediction engine for the virtual event. In some embodiments, the virtual event is a cold start virtual event. In some embodiments, the recommendation and prediction engine is configured to request and receive information from a user at the event. In some embodiments, the inputted information identifies various topics or areas of interest of the user. Such areas of interest include, e.g., topics, speakers, companies, entertainment, sponsors, and sub-event sessions related to the same. In some embodiments, the systems and methods analyze entity biographies, social media profiles, company webpages, or other information to make inferences and connections between entities.

In some embodiments, the recommendation and prediction engine is further configured to formulate and display user-specific recommendations. The outputted display of user-specific recommendations can include, e.g., other attendees, particular speakers, contacts, sub-events within the virtual event (e.g., keynote presentations, meetings, breakout groups), exhibition booths, or any other recommendations matching the user's inputted areas of interest. A match means the entities have a relationship with the same entity.

In some embodiments, the systems and methods include a prediction engine that is utilized, for example, by a business attending the event, a sponsor of the event, or an event administrator, to predict which attendees have a high spending propensity. In such embodiments, the systems and methods perform lead scoring for each attendee.

In some embodiments, the lead score may be a normalized score having a continuous floating point value between a minimum and a maximum score (e.g., between 0 and 100). In one example, the recommendation and prediction engine gets signals from the lead scoring machine learning models to compute the matching score between a sponsor and an attendee of the event. The lead scoring model can run a personalized ranking process that can rate or measure the entire attendee base of a particular event. This ranking is based on the similarities attendees have against a set of customizable parameters or scoring criteria defined by an event administrator (a business attending the event). Those customizable parameters fall into three main categories including the following: 1. Attributes-based parameters, 2. direct interactions-based parameters, 3. areas of interest-based parameters.

Under attribute based parameters are sub-parameters such as title, seniority, location of the attendee, and the attendee's affiliated organization related specifics such as the number of employees, estimated annual revenue, industry, organization location, etc. The system may run a large-scale attendee profile enrichment processes in the backend to fill the missing information from attendee profiles. Based on an internal voting process, the prediction engine then weighs these parameters to compute the attributes score.

Under direct interactions based parameters, the event administrator can select the interested entities from all the sponsored entities in events such as sponsored booths, roundtables, and ancillary events. The prediction system then assesses all the interactions attendees had with those selected entities, such as booth visits, booth resource downloads, roundtable participation, etc. Based on an internal voting process, the prediction engine then weighs attendees' interactions to compute the direct interactions score.

When running a scoring job, the event administrator can specify a sub-set of areas of interest out of all the areas of interest tags existent for the event. The prediction engine pre-calculates an AOI (Area of Interest) score for all the attendees for all the AOIs. This score is pre-calculated in a near real-time fashion based on many event-wide interactions and activities of the attendees. For example, here the prediction engine considers all the session, booth, and roundtable interactions of an attendee that are tagged with any given AOI. Based on an internal voting process, the prediction engine then weighs attendees' interactions with those AOIs to compute the AOI score.

The prediction engine combines the attributes, direct interactions, and AOI scores for each attendee based on the weights coming from an machine learning based voting process. This combined score is used to rank the attendees or prospective leads for the event administrator. Since this score considers characteristics specific to that particular sponsor, this creates a personalized matching score for the event sponsor.

In some embodiments, the recommendation engine is used by entities to analyze how a user interacts with other entities during the virtual event. In some embodiments, the recommendation and prediction engine clusters entities into groups based on their interactions and interests. The recommendation engine may then recommend exhibitor booths, events at the conference, and attendees with similar or complementary relationships. In some embodiments, a concierge (a person or a bot) will interact with entities in real-time to moderate interactions (e.g., conversations) between, e.g., an attendee and business.

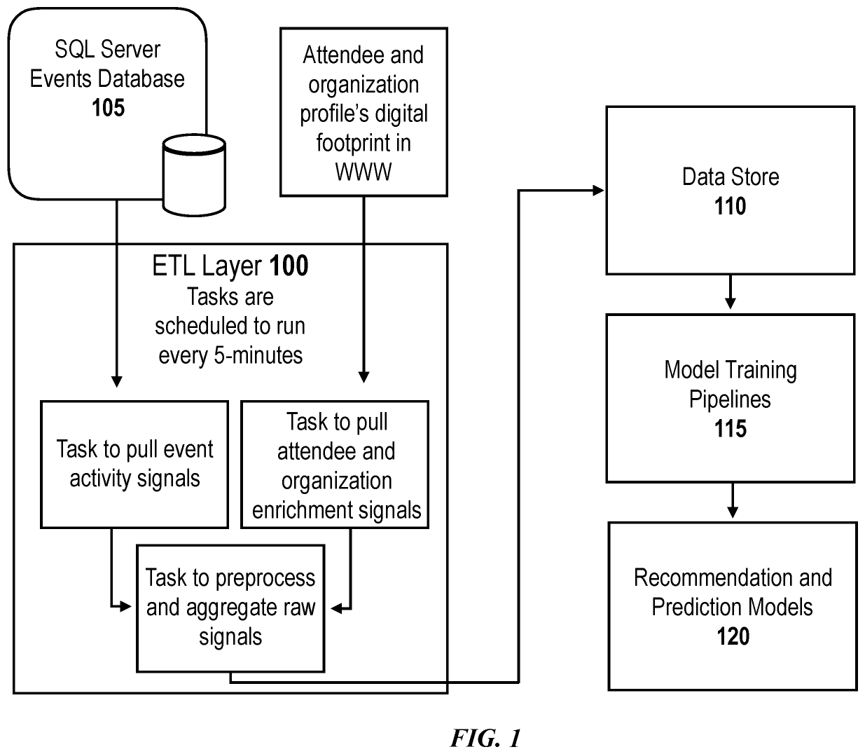

In reference to FIG. 1, the recommendation and prediction engine's ETL 100 (Extract, transform, load) and machine learning model training pipeline is designed to solve the cold-start problem of virtual events. The events database 105 is the main transactional database of the events platform and contains user information and any event activity data such as session participation, chats, booths, roundtables, gamification etc. During the early launch phase of the event there is limited user activity or interactions in the events database 105. In this phase all activities are seen around the attendee/sponsor signup sections. Lack of activity data makes it challanging for the recommendation and prediction engine to provide accurate results. To overcome this, the recommendation and prediction engine periodically pulls data and enrichment signals from different public and paid sources to enrich the attendee and organization profiles with their digital footprint (Firmographic and Demographic data). These enrichments include up-to-date social, blog, and recent news signals data. The enrichment process allows the recommendation and prediction engine to add more metadata signals to attendee profiles for better attendee to attendee networking and event content discovery. The ETL layer 100 consists of following tasks to:
pull millions of event activity signals from the events database 105,
pull end-users' and their organization's enrichment signals from the World Wide Web,
pre-process aggregate both event and enrichment data and dump them in the data store 110.

These tasks are placed in an Airflow DAG (Directed Acyclic Graph). Airflow is a platform to programmatically author, schedule, and monitor workflows using DAGs. A DAG is a collection of tasks, organized in a way that reflects their relationships and dependencies. The processed data sent over to the data store 110 will be consumed by the model training pipelines 115.

The recommendation and prediction engine consists of multiple machine learning models to generate recommendations, predictions, and matching scores. All of these models, including the recommendation and prediction model 120 are trained using the data persisted in the data store 110.

In some embodiments, the data store 110 is powered by Redis and Kafka. Apache Kafka is an open-source stream-processing software to provide a unified, high-throughput, low-latency platform for handling real-time data feeds. Redis is an in-memory data structure store, used as a distributed, in-memory key-value database, cache, and message broker, with optional durability. Some of the machine learning models in the model training pipeline 115 use the processed data in Kafka, while the rest of the models use Redis as a data source. In Redis, the processed data persists as JSON Graphs.

Prior to utilizing this method, within the ETL layer 100, a graph database was used to keep the entities as nodes and semantic relationships between those entities as vertices in the graph database. The events have a complex ecosystem that contains many entities, such as attendees, speakers, sponsors, booths, roundtables, happy hours, chats, etc. There are also many heterogeneous and homogeneous semantic relationships between these entities. A graph database as the go-to database approach to reflect this complex ecosystem for the use of the recommendation and prediction engine. However, it was found out that this graph-based implementation does not scale up to the required standards. The graph database could not handle events with loads of over five thousand concurrent users, as the queries were also complex. In worst cases, a single query could hit the graph database up to 20,000 times. It added an unacceptable latency when querying the database. The system experienced unacceptable levels of API timeouts due to the inefficiencies of the graph database. In events testing scenarios, the standard queries' average response time was around 6 minutes, which was unacceptable.

There was the requirement to support many events within the same graph database, which could significantly increase the database size as the number of nodes could extend up to billions. Graph databases handle this problem effectively. Therefore, the graph database substitute may also support that many entities.

The data persistence layer does not use a graph database but comes with the ability to persist a large-scale graph data structure with optimizations in all the avenues such as storage, read and write times. An optimized JSON Graph structure is provided that can fit inside an in-memory data structure store such as Redis. JSON Graph is a convention for modeling graph information as a JSON object. After integrating the Redis-based JSON Graph, the average response time of the standard queries was around 100 milliseconds. In some embodiments, the performance is improved by a factor of about 100, or about 200, or about 500, or about 1000, when using the JSON graph data object compared to the graph database.

In such embodiments, the ETL service can handle millions of records in the SQL database in seconds in a single sync. In some embodiments, the single sync takes an average of fewer than 2 minutes, or less than 1 minute, or less than 45 seconds, or less than 35 seconds, or less than 30 seconds. In other embodiments, the single sync takes an average of between 5 seconds and 2 minutes, or between 10 seconds to about 60 seconds, or between 25 seconds and 35 seconds.

In some embodiments, the model training pipelines 115 are powered by both Spark and TensorFlow. Apache Spark is an open-source distributed general-purpose cluster-computing framework. TensorFlow is a free and open-source software library for machine learning. It can be used across a range of tasks but has a particular focus on training and inference of deep neural networks. Machine learning models in this layer are responsible for recommending and predicting matching attendees, sponsors, sessions, advertisements, ancillary events to the end-user.

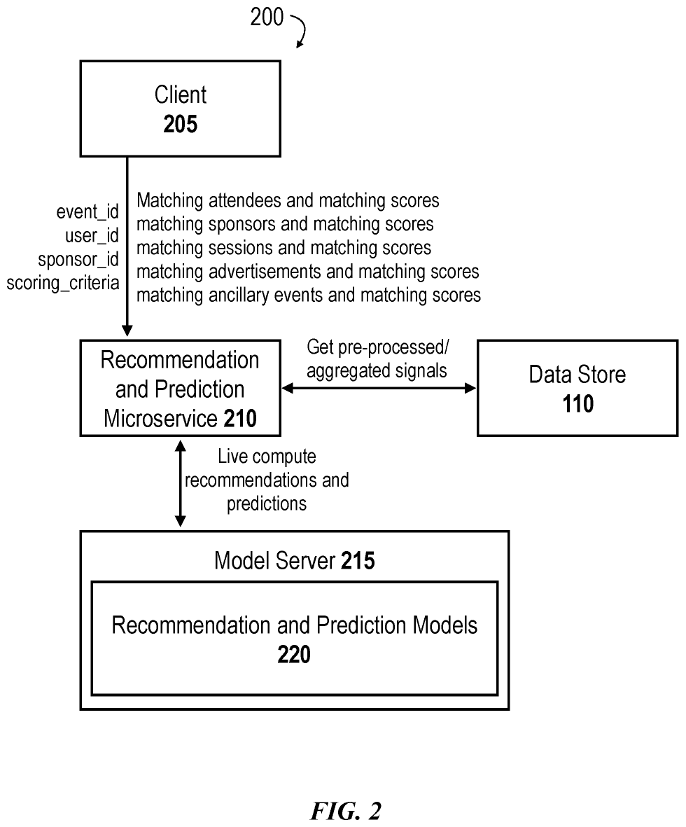

FIG. 2 illustrates a flowchart of the inference pipeline 200 of the recommendation and prediction engine. The client 205 could be an event attendee or an event administrator from a sponsoring organization. The client calls the recommendation and prediction microservice 210 along with event id, user id, sponsor id, and scoring criteria as input arguments. Then, the recommendation and prediction microservice 210 consumes the pre-processed and aggregated signals from the data store to be used as inputs for the machine learning model server 215. The model server 215 utilizes the trained machine learning models 220 to recommend and predict outputs based on the input signals. The predicted outputs could be a collection of matching attendees & matching scores, matching sponsors & matching scores, matching sessions & matching scores, matching advertisements & matching scores, matching ancillary events & matching scores.

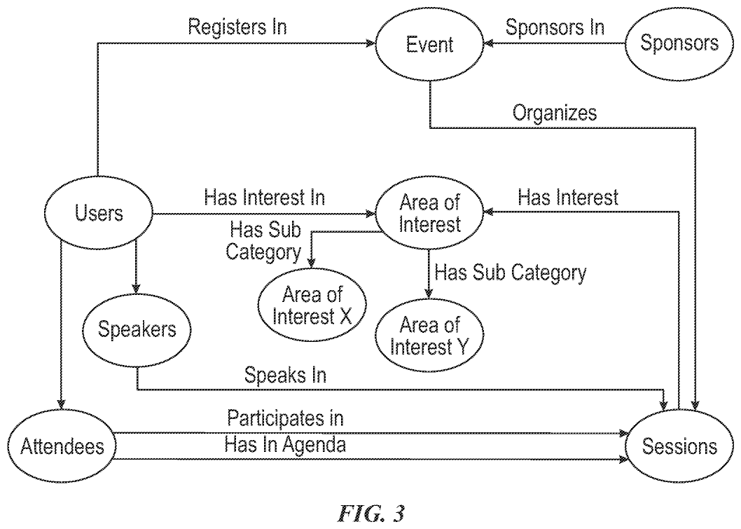

FIG. 3 illustrates an example of memory-optimized JSON (JavaScript Object Notation) graph-based event data representation 300. In some embodiments, the graph includes nodes for each entity (e.g., attendee, speaker, area of interest). In such embodiments, the interconnecting lines between two or more entities represent a relationship. In some embodiments, the JSON graph is a convention for modeling graph information as a JSON object. As shown in FIG. 3, for example, the Event, Speakers, and Attendees are connected to the Sessions, and the Sessions are connected to an Area of Interest shared by the Users. Therefore, the Attendees and Speakers have a relationship with the Sessions, and the Users and Sessions have a relationship through the Areas of Interest. As such, each relationship between all the nodes is shown in the JSON object.

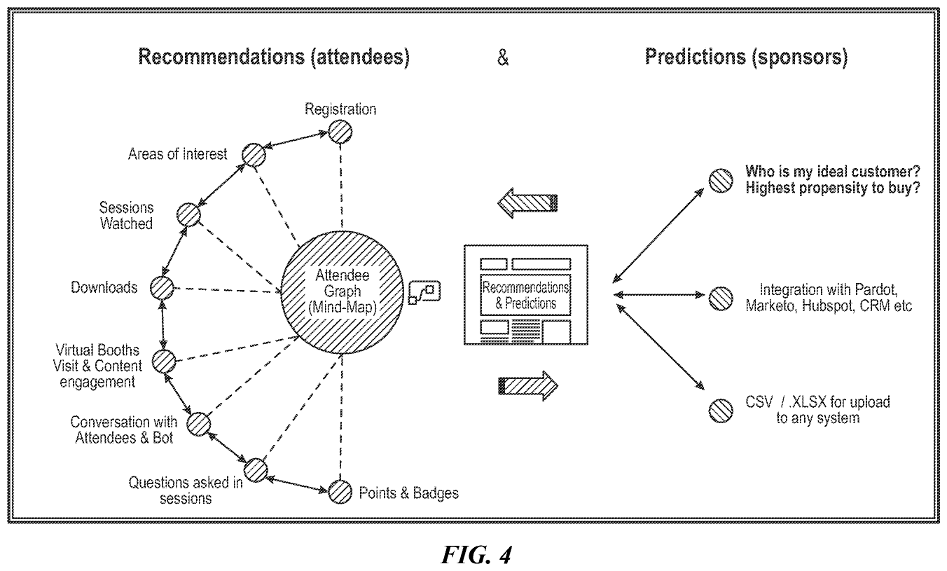

FIG. 4 illustrates a display showing a recommendations and predictions output. As shown in the figure, the attendee graph on the left side maps out the various categories of information associated with the user since the user registered for the virtual event. In this example, the categories of information include Registration, Areas of Interest, Sessions Watched, Downloads, Virtual exhibition booths visited, Conversations with other attendees or bots, Questions asked during sessions or sub-events, and Points and Badges. Because each of the different categories of information is in separate nodes, the information for the specific attendee can then be quickly compared to the corresponding information in an associated node for other attendees, sponsors, companies, etc. The right side of the diagram shows the Predictions information for the attendee. That information is helpful to sponsors, for example, for determining who the ideal customers are or who has the highest propensity to buy a product or service from the user.

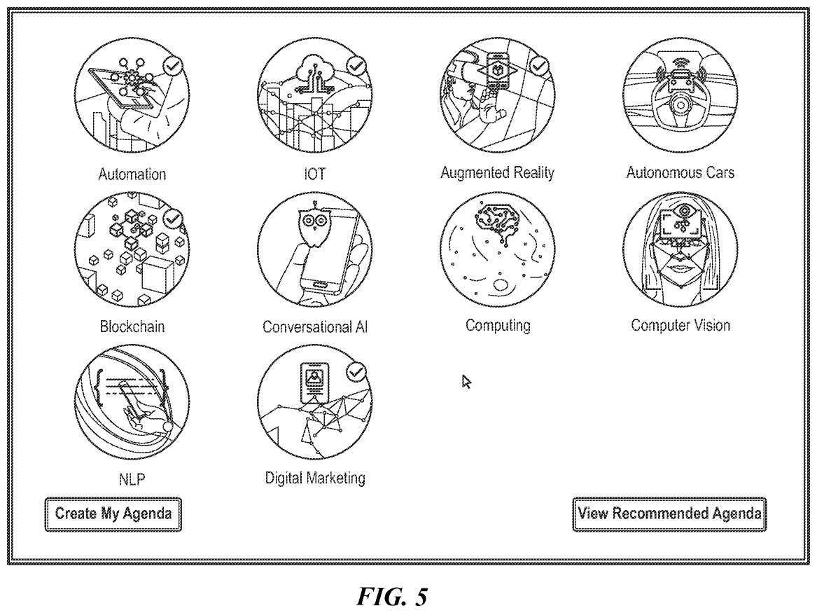

FIG. 5 illustrates a display showing certain potential areas of interest that a user can select during virtual event onboarding. In some embodiments, the areas of interest include topics related to the virtual event, sessions related to specific topics, featured speakers, sponsors, sub-events (e.g., happy hour or other entertainment options), etc. When onboarding, the user selects any topic that may be of interest. In some embodiments, the selected areas of interest can be supplemented with user-specific preferences. For example, the user may be most interested in attending a session on autonomous cars, less interested in blockchain technology, and not interested in digital marketing. In such an example, the icon for autonomous cars can be selected and ranked highest (e.g., 1), the icon for blockchain technology can be selected and ranked lower (e.g., 2), and the icon for digital marketing can remain unselected. Additional displays requesting further information are contemplated. In some embodiments, a display providing a menu of categories or options related only to a particular area of interest can be provided to further specify a user's interest. For example, a menu of sessions, meetings, sponsored sub-events, etc. for autonomous cars list specific speakers, companies, or sub-topics (e.g., safety, regulations, etc.) can request more detailed information from the user. The input of these selections assigns attributions to the user.

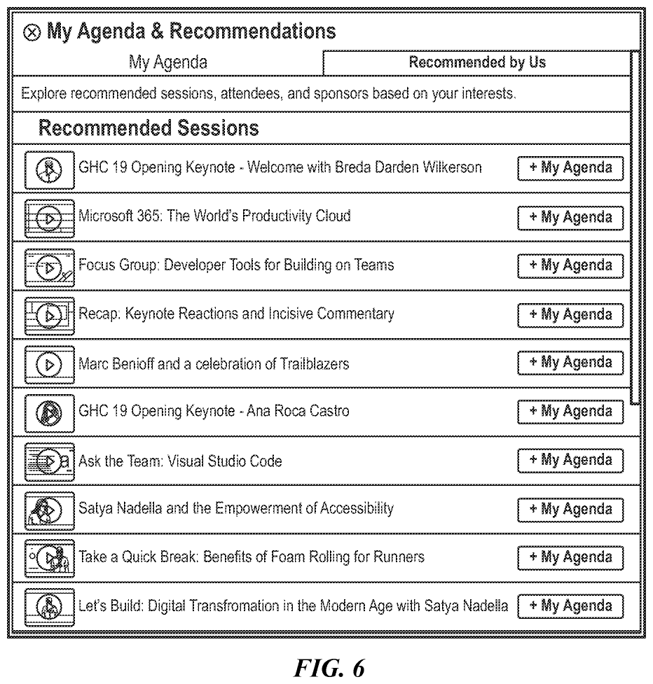

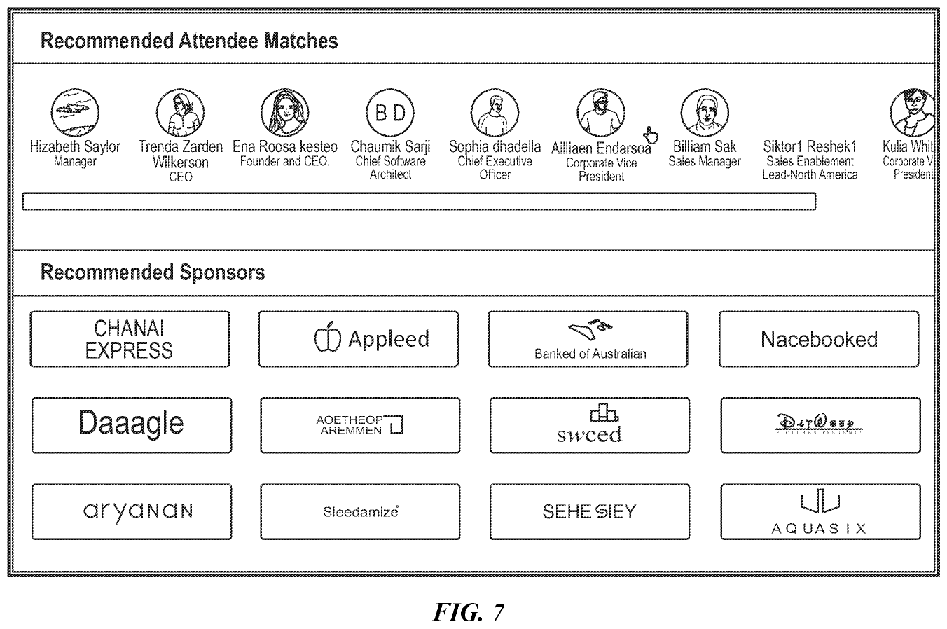

FIG. 6 illustrates a display showing virtual event recommendations for a user based on the areas of interest selected by the user during the onboarding process. In some embodiments, the display comprises a section (e.g., a tab as shown in FIG. 7) for the user's current agenda, and a separate section for the user-specific recommendations. Initially, the user's agenda can be empty or pre-populated. In some embodiments, for example, the user's agenda is pre-populated with the most popular or keynote events. In some embodiments, the user-specific recommendations can be selected for inclusion in the user's agenda list. For example, if the user selects “Focus Group: Developer Tools for Building on Teams” on the recommendations list, as shown in FIG. 6, then the sub-event will be added to the user's agenda list.

FIG. 7 illustrates a display showing recommendations. In some embodiments, the recommendations are divided and/or subdivided into categories such as, e.g., attendee matches and sponsor recommendations. As shown in FIG. 7, the (user) attendee can select other attendees or sponsors from a group of attendees and sponsors determined to be a match based on one or more shared areas of interest, relationships, event experiences, etc. Accordingly, if an objective of the attendee (user) is to expand her network to include people in a selected category (e.g., automated cars), then the user can identify such people from the recommended list rather than considering the entire list of event attendees.

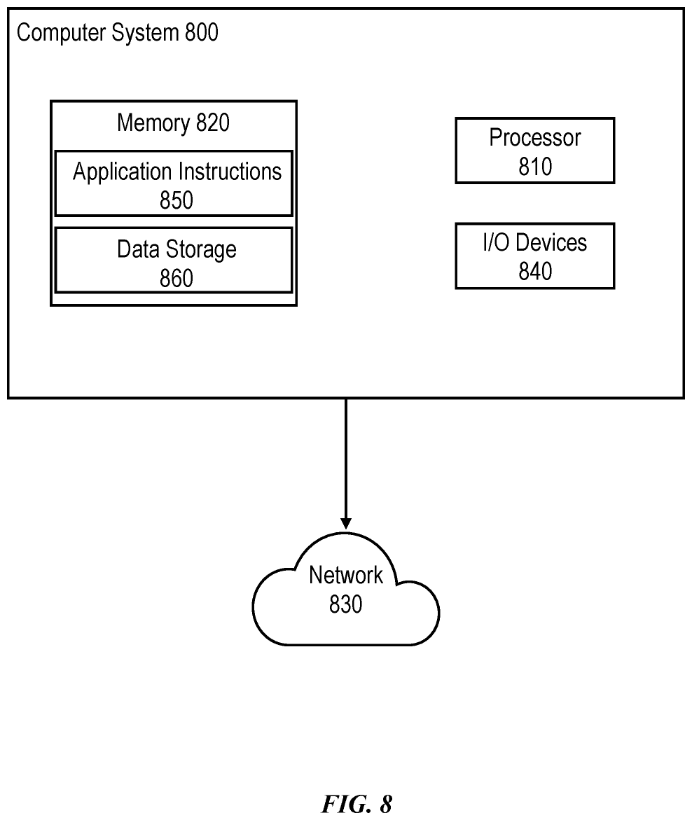

FIG. 8 illustrates a computer system 800, which may be utilized to execute the processes described herein. The computer system 800 is comprised of a standalone computer or mobile computing device, a mainframe computer system, a workstation, a network computer, a desktop computer, a laptop, or the like. The computer system 800 includes one or more processors 810 coupled to a memory 820 via an input/output (I/O) interface. Computer system 800 may further include a network interface to communicate with the network 830. One or more input/output (I/O) devices 840, such as video device(s) (e.g., a camera), audio device(s), and display(s) are in operable communication with the computer system 800. In some embodiments, similar I/O devices 840 may be separate from computer system 800 and may interact with one or more nodes of the computer system 800 through a wired or wireless connection, such as over a network interface.

Processors 810 suitable for the execution of a computer program include both general and special purpose microprocessors and any one or more processors of any digital computing device. The processor 810 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 800 and other devices attached to a network 830, such as other computer systems, or between nodes of the computer system 800. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 820 may include application instructions 850, configured to implement certain embodiments described herein, and a database 860, comprising various data accessible by the application instructions 850. In one embodiment, the application instructions 850 may include software elements corresponding to one or more of the various embodiments described herein. For example, application instructions 850 may be implemented in various embodiments using any desired programming language, scripting language, or combination of programming languages and/or scripting languages (e.g., C, C++, C#, JAVA, JAVASCRIPT, PERL, etc.).

The steps and actions of the computer system 800 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 810 such that the processor 810 can read information from, and write information to, the storage medium. In the alternative, the storage medium may be integrated into the processor 810. Further, in some embodiments, the processor 810 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

Many different embodiments have been disclosed herein in connection with the above description and the drawings. It will be understood that it would be unduly repetitious and obfuscating to describe and illustrate every combination and sub-combination of these embodiments. Accordingly, all embodiments can be combined in any way, and the present specification, including the drawings, shall be construed to constitute a complete written description of all combinations and sub-combinations of the embodiments described herein, and of the manner and process of making and using them, and shall support claims to any such combination or sub-combination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a sub-combination or variation of a sub-combination.

It will be appreciated by persons skilled in the art that the present embodiment is not limited to what has been particularly shown and described hereinabove. A variety of modifications and variations are possible in light of the above teachings without departing from the following claims.

I claim:

1. A system for making recommendations and predictions to an end-user of a virtual event or hybrid event, comprising:
a virtual event platform to provide an interactive user interface for a virtual event;
a recommendation and analytics server to receive a plurality of interests and transmit the plurality of interests to an analytics engine and recommendation engine, wherein the analytics engine and recommendation engine provide a response including one or more results to the user via the recommendation and prediction engine.

2. The system of claim 1, further comprising one or more model training pipelines.

3. The system of claim 2, wherein the one or more model training pipelines receive information from the data store.

4. The system of claim 1, wherein the one or more model training pipelines transmit information to one or more recommendation and prediction models.

5. The system of claim 1, wherein a client calls a recommendation and prediction microservice.

6. The system of claim 5, wherein the recommendation and prediction microservice consumes pre-processed and aggregated signals from a data store.

7. The system of claim 6, wherein the pre-processed and aggregated signals are utilized as outputs for a machine learning model server.

8. The system of claim 7, further comprising an ETL layer to perform the following: pull event activity and pull enrichment signals.

9. The system of claim 8, wherein the ETL layer transmits the event activity and the enrichments signals to the data store.

10. A system for making recommendations and predictions to an end-user of a virtual event or hybrid event, comprising:
a virtual event platform to provide an interactive user interface for a virtual event;
a recommendation and analytics server to receive a plurality of interests and transmit the plurality of interests to an analytics engine and recommendation engine, wherein the analytics engine and recommendation engine provide a response including one or more results to the user via the recommendation and prediction engine, the recommendation and prediction engine comprising a plurality of machine learning models to generate one or more recommendations, one or more predictions, and one or more matching scores to the user.

11. The system of claim 10, wherein the plurality of machine learning models are trained via a data store.

12. The system of claim 11, further comprising a recommendation and prediction microservice to compute the one or more recommendations, and the one or more predictions.

13. The system of claim 12, further comprising a lead scoring model configured to operate a personalized ranking process to rate an attendee base of the event.

14. The system of claim 13, wherein the personalized ranking process includes a set of customizable parameters defined by an event administrator.

15. The system of claim 14, wherein the customizable parameters include at least one of the following: attributes-based parameters, direct interactions-based parameters, and areas of interest-based parameters.

16. The system of claim 15, wherein the prediction engine combines attributes, direct interactions, and areas of interest scores for each attendee of the event.

17. The system of claim 16, further comprising one or more model training pipelines.

18. The system of claim 17, wherein the one or more model training pipelines receive information from the data store.

19. The system of claim 18, wherein the one or more model training pipelines transmit information to the recommendation and prediction models.

20. A system for making recommendations and predictions to an end-user of a virtual event or hybrid event, comprising:
a virtual event platform to provide an interactive user interface for a virtual or a hybrid event;
a recommendation and analytics server to receive a plurality of interests and transmit the plurality of interests to an analytics engine and recommendation engine, wherein the analytics engine and recommendation engine provide a response including one or more results to the user via the recommendation and prediction engine, the recommendation and prediction engine comprising a plurality of machine learning models to generate one or more recommendations, one or more predictions, and one or more matching scores to a user;
a recommendation and prediction microservice to compute the one or more recommendations, and the one or more predictions;
an ETL layer to pull a plurality of event signals, a plurality of attendee and organization signals, and to preprocess and aggregate the plurality of event signals and the plurality of attendee and organization signals, wherein the the plurality of event signals and the plurality of attendee and organization signals are transmitted to a data store in communication with the recommendation and prediction engine.
